(19) United States
(12) Patent Application Publication
(10) Pub. No.: US 2026/0257707 A1
(43) Pub. Date: Sep. 3, 2026

(54) METHOD AND SYSTEM FOR PROTECTING OPERATIONS IN A VACUUM ENVIRONMENT OF AN ULTRA-HIGH-SPEED MAGNETIC LEVITATION LOW VACUUM TUBE

(71) Applicant: CRSC RESEARCH & DESIGN INSTITUTE GROUP CO., LTD., Beijing (CN)

(72) Inventors: Yunguang JIA, Beijing (CN); Junfeng CUI, Beijing (CN); Wenhua YAO, Beijing (CN); Xin ZHAN, Beijing (CN); Ling LIU, Beijing (CN); Rong CHENG, Beijing (CN); Yiling CHEN, Beijing (CN)

(21) Appl. No.: 18/866,345

(22) PCT Filed: Oct. 14, 2024
(86) PCT No.: PCT/CN2024/124705

§ 371 Date: Nov. 15, 2024

(30) Foreign Application Priority Data
Mar. 22, 2024 (CN) 202410335951.8

(51) Int. Cl. B61L 27/20; B61B 13/08; B61B 13/10

(52) U.S. Cl. CPC B61L 27/20; B61B 13/08; B61B 13/10; B61L 2210/04

(57) ABSTRACT

A method and a system for protecting operations in a vacuum environment of an ultra-high-speed magnetic levitation low vacuum tube are provided. The method includes the following steps: firstly, establishing, by a vacuum tube monitoring system, an air diffusion model based on pressure and air velocity in a vacuum tube; and secondly, controlling, by a central operation control system, based on the air diffusion model, an on-board operation control system through a partition operation control system to control an operating status of a train.

### TECHNICAL FIELD

The invention belongs to the field of rail traffic, and in particular relates to a method and system for protecting operations in a vacuum environment of an ultra-high-speed magnetic levitation low vacuum tube.

### BACKGROUND

A low vacuum tube magnetic levitation transportation system (or Hyper-speed Train) is a subversive and forward-looking strategic project. After its successful research and development, the magnetic levitation transportation system will be a world-class modern integrated transportation system with aviation and high-speed rail. When a low vacuum tube high-speed magnetic levitation train runs in a vacuum tube, in order to ensure the high-speed magnetic levitation train operating at a high speed, the operating tube needs to be in a low vacuum status. Therefore, a vacuum tube control system needs to be established to ensure the vacuum tube under a certain pressure value, and then ensure that the tube is in a vacuum status.

When a high-speed train runs at a high speed, because air pressure and air flow are main factors for train operating, so monitoring a vacuum tube is particularly important. As an infrastructure of high-speed trains, the vacuum tube is involved in the safety status of the main line of the train. Whether the vacuum tube is in a vacuum status may affect the train's brake curve, movement authorization, and section occupation status. Once the vacuum tube-related valves, escape doors and vacuum pumps and so on experience a malfunction or tube leakage, this may cause harm to the operation of high-speed magnetic levitation trains.

So how to ensure train operating safety in a low vacuum tube is becoming an urgent technical problem.

### SUMMARY

In view of the above problems, the present invention discloses a method and system for protecting operations in a vacuum environment of an ultra-high-speed magnetic levitation low vacuum tube, and the method and system improve the safety and reliability of train operation.

The invention aims to provide a method for protecting operations in a vacuum environment of an ultra-high-speed magnetic levitation low vacuum tube, comprising:
establishing, by a vacuum tube monitoring system, an air diffusion model based on pressure and air velocity in a vacuum tube; and
controlling, by a central operation control system, based on the air diffusion model, an on-board operation control system through a partition operation control system to control an operating status of a train.

Further, the establishing, by a vacuum tube monitoring system, an air diffusion model based on pressure and air velocity in a vacuum tube comprises:
determining, based on a pressure change rate in the vacuum tube, whether current air in the vacuum tube is in a stable status,
if the current air in the vacuum tube is in the stable status, determining an operating status of the train based on the pressure and/or the air velocity in the vacuum tube; and
otherwise, determining the operating status of the train based on the pressure change rate in the vacuum tube.

Further, the pressure change rate δP in the vacuum tube satisfies:

δP=(P1−P2)/t1−t2
wherein, P1 represents the pressure at time t1, and P2 represents the pressure at time t2;
when δP=0, it indicates that the current air in the vacuum tube is in the stable status; and
when δP≠0, it indicates that the current air in the vacuum tube is in an unstable status.

Further, if the current air in the vacuum tube is in the stable status, or if the current air in the vacuum tube is in the unstable status, but 0<δP≤a first pressure change rate, the determining an operating status of the train based on the pressure and/or the air velocity in the vacuum tube comprises:
if the pressure P in the vacuum tube<a first pressure, then making the operating status of the train and the air velocity Vair in the vacuum tube satisfy following relationships that:
when Vair≤a first air velocity V1, the train travels at a normal operating speed;
when the first air velocity V1<Vair≤a second air velocity V2, the train travels at a speed less than a first operating speed;
when the second air velocity V2<Vair≤a third air velocity V3, the train travels at a speed less than a second operating speed;
when the third air velocity V3<Vair≤a fourth air velocity V4, the train travels
with support wheels lowered;
when Vair>the fourth air velocity V4, the train stops; and
if the pressure P in the vacuum tube≥the first pressure, the train travels at the normal operating speed.

Further, if the current air in the vacuum tube is in the unstable status but δP>the first pressure change rate, the determining an operating status of the train based on the pressure change rate in the vacuum tube comprises that:
when the first pressure change rate<δP≤a second pressure change rate, the train travels with the support wheels lowered; and
when δP>the second pressure change rate, the train stops.

Further, the controlling, by a central operation control system, based on the air diffusion model, the on-board operation control system through the partition operation control system to control the operating status of the train comprises:

if Vair>the fourth air velocity V4 or δP>the second pressure change rate, by the central operation control system, sending a braking control instruction to the partition operation control system, and by the partition operation control system, controlling the train to brake and stop through the on-board operation control system.

Further, the controlling, by the central operation control system, based on the air diffusion model, the on-board operation control system through the partition operation control system to control the operating status of the train further comprises:
if the first air velocity V1<Vair≤the fourth air velocity V4 or the first pressure change rate<δP≤the second pressure change rate, by the central operation control system, calculating a temporary speed limit, and sending a temporary speed limit instruction and the calculated temporary speed limit to the partition operation control system; and
controlling, by the partition operation control system, the operating status of the train through the on-board operation control system, based on the temporary speed limit instruction and the temporary speed limit.

Further, the controlling, by the partition operation control system, the operating status of the train through the on-board operation control system, based on the temporary speed limit instruction and the temporary speed limit further comprises:
by the partition operation control system, obtaining a levitation speed of the train through the on-board operation control system, and determining whether the temporary speed limit of the train is lower than the levitation speed,
if the temporary speed limit is lower than the levitation speed, by the partition operation control system, controlling the train to lower the support wheels through the on-board operation control system, and after the support wheels of the train land, controlling the train to pass through a speed limited area at the temporary speed limit; and
otherwise, by the partition operation control system, controlling the train to pass through the speed limited area at the levitation speed through the on-board operation control system.

Further, the method further comprises: by a vacuum tube monitoring system, controlling operations of a gate valve, a return pressure valve, an escape door and/or a vacuum pump under permission from the partition operation control system, specifically comprising:
by the vacuum tube monitoring system, sending an operating status instruction to the partition operation control system;
by the partition operation control system, checking whether the train is in a stopped status through the on-board operation control system based on the operation status instruction,
allowing the vacuum tube monitoring system to control the operations of the gate valve, the return pressure valve, the escape door and/or the vacuum pump if the train is in the stopped status; and
otherwise, not allowing the vacuum tube monitoring system to control the operations of the gate valve, the return pressure valve, the escape door and/or the vacuum pump.

Further, the method further comprises: by a central operation control system, remotely controlling the operations of the gate valve, the return pressure valve, the escape door and/or the vacuum pump, under permission from the partition operation control system, specifically comprising,
by the central operation control system, sending an operating status instruction to the partition operation control system;
by the partition operation control system, checking whether the train is in a stopped status through the on-board operation control system based on the operation status instruction,
if the train is in the stopped status, allowing the central operation control system to remotely control the operations of the gate valve, the return pressure valve, the escape door and/or the vacuum pump; and
otherwise, not allowing the central operation control system to remotely control the operations of the gate valve, the return pressure valve, the escape door and/or the vacuum pump.

Another aim of the present invention is to provide a system for protecting operations in a vacuum environment of an ultra-high-speed magnetic levitation low vacuum tube, comprising a central operation control system, a partition operation control system, an on-board operation control system and a vacuum tube monitoring system, wherein the central operation control system is connected to the partition operation control system and the vacuum tube monitoring system respectively, and the partition operation control system is further connected to the vacuum tube monitoring system and the on-board operation control system respectively, wherein,
the vacuum tube monitoring system is configured to obtain pressure and air velocity in a vacuum tube, and establish an air diffusion model based on the pressure and the air velocity in the vacuum tube; and
the central operation control system is configured to control the on-board operation control system through the partition operation control system to control an operating status of the train.

Further, the establishing the air diffusion model based on the pressure and the air velocity in the vacuum tube comprises:
determining, based on a pressure change rate in the vacuum tube, whether current air in the vacuum tube is in a stable status; wherein, the pressure change rate δP in the vacuum tube satisfies:

$$δ P = ( P 1 - P 2 ) / t 1 - t 2$$

wherein, P1 represents the pressure at time t1, and P2 represents the pressure at time t2;
when δP=0, it indicates that the current air in the vacuum tube is in the stable status; when δP≠0, it indicates that the current air in the vacuum tube is in an unstable status;
wherein if the current air in the vacuum tube is in the stable status, or if the current air in the vacuum tube is in the unstable status, but 0<δP≤a first pressure change rate, then the operating status of the train is determined based on the current pressure and/or air velocity in the vacuum tube, wherein,
if the pressure P in the vacuum tube<a first pressure, then the operating status of the train and the air velocity Vair in the vacuum tube satisfy following relationships that:
when Vair≤the first air velocity V1, the train travels at the normal operating speed;
when the first air velocity V1<Vair≤a second air velocity V2, the train travels at a speed less than the first operating speed;
when the second air velocity V2<Vair≤a third air velocity V3, the train travels at a speed less than the second operating speed;
when the third air velocity V3<Vair≤a fourth air velocity V4, the train travels with the support wheels lowered;
when Vair>a fourth air velocity V4, the train stops;
if the pressure P in the vacuum tube≥the first pressure, the train travels at the normal operating speed, and
if the current air in the vacuum tube is in the unstable status, but δP>the first pressure change rate, determining the operating status of the train based on the pressure change rate in the vacuum tube, wherein
when the first pressure change rate<δP≤a second pressure change rate, the train travels with the support wheels lowered; and
when δP>the second pressure change rate, the train stops.

Further, the controlling the on-board operation control system through the partition operation control system to control the operating status of the train, based on the air diffusion model, comprises:
if Vair>the fourth air velocity V4 or δP>the second pressure change rate, by the central operation control system, sending a braking control instruction to the partition operation control system, and by the partition operation control system, controlling the train to brake and stop through the on-board control system.

Further, the controlling the on-board operation control system through the partition operation control system to control the operating status of the train, based on the air diffusion model, comprises:
if the first air velocity V1<Vair≤the fourth air velocity V4 or the first pressure change rate<δP≤the second pressure change rate, by the central operation control system, calculating the temporary speed limit, and sending a temporary speed limit instruction and the calculated temporary speed limit to the partition operation control system;
the controlling, by the partition operation control system, the operating status of the train through the on-board operation control system, based on the temporary speed limit instruction and the temporary speed limit comprises:
by the partition operation control system, obtaining a levitation speed of the train through the on-board operation control system, and determining whether the temporary speed limit of the train is lower than the levitation speed,
if the temporary speed limit is lower than the levitation speed, by the partition operation control system, controlling the train to lower the support wheels through the on-board operation control system, and after the support wheels of the train land, controlling the train to pass through a speed limited area at the temporary speed limit; and
otherwise, by the partition operation control system, controlling the train to pass through the speed limited area at the levitation speed through the on-board operation control system.

Further, the vacuum tube monitoring system is further configured to control operations of a gate valve, a return pressure valve, an escape door and/or a vacuum pump, under permission from the partition operation control system, specifically comprising,
by the vacuum tube monitoring system, sending an operating status instruction to the partition operation control system;
by the partition operation control system, checking whether the train is in a stopped status through the on-board operation control system based on the operation status instruction,
allowing the vacuum tube monitoring system to control the operations of the gate valve, the return pressure valve, the escape door and/or the vacuum pump if the train is in the stopped status; and
otherwise, not allowing the vacuum tube monitoring system to control the operations of the gate valve, the return pressure valve, the escape door and/or the vacuum pump.

Further, the central operation control system is further configured to control the operations of the gate valve, the return pressure valve, the escape door and/or the vacuum pump, under permission from the partition operation control system, specifically comprising,
by the central operation control system, sending an operating status instruction to the partition operation control system;
by the partition operation control system, checking whether the train is in a stopped status through the on-board operation control system based on the operation status instruction,
if the train is in the stopped status, allowing the central operation control system to remotely control the operations of the gate valve, the return pressure valve, the escape door and/or the vacuum pump; and
otherwise, not allowing the central operation control system to remotely control the operations of the gate valve, the return pressure valve, the escape door and/or the vacuum pump.

Another aim of the present invention is to provide a system for protecting operations in a vacuum environment of an ultra-high-speed magnetic levitation low vacuum tube, comprising a central operation control system, a partition operation control system, an on-board operation control system and a vacuum tube monitoring system, wherein the central operation control system is connected to the partition operation control system and the vacuum tube monitoring system respectively, and the partition operation control system is further connected to the vacuum tube monitoring system and the on-board operation control system respectively, wherein,
the vacuum tube monitoring system includes an air diffusion calculation module, a control subsystem, an environment sensing subsystem, a door valve, a return pressure valve, an escape door, a vacuum pump, an air pressure sensor and an air velocity sensor, wherein the air pressure sensor and the air velocity sensor are respectively connected to the environment sensing subsystem and are configured to collect pressure and air velocity in the vacuum tube respectively, and the air diffusion calculation module is connected to the environment sensing subsystem and is configured to calculate the pressure and the air velocity in the vacuum tube provided by the environment sensing subsystem, to establish an air diffusion model; and the control subsystem is connected with the gate valve, the return pressure valve, the escape door, and the vacuum pump in the vacuum tube, and is configured to control the gate valve, the return pressure valve, the escape door, and the vacuum pump;
the central operation control system comprises a temporary speed limit automatic calculation module and a global automatic emergency instruction module, wherein the temporary speed limit automatic calculation module is connected with the global automatic emergency instruction module, wherein the global automatic emergency instruction module is connected with the air diffusion calculation module of the vacuum tube monitoring system for obtaining an air diffusion model and sending the air diffusion model to the temporary speed limit automatic calculation module, wherein the temporary speed limit calculation module is configured to calculate a temporary speed limit based on the air diffusion model; and
the partition operation control system is configured to control an operating status of the train through the on-board operation control system according to a control instruction sent by the central operation control system based on the air diffusion model.

Further, the central operation control system further comprises a remote operation terminal for remotely controlling operations of the gate valve and the return pressure valve, the escape door, and the vacuum pump.

Further, the partition operation control system is further configured to monitor the gate valve, the return pressure valve, the escape door, and the vacuum pump, and before the central operation control system or the control subsystem controls the operations of the gate valve, the return pressure valve, the escape door and/or the vacuum pump, permission confirmation is performed.

When the protection method and system of the present invention protect the safe operation of the magnetic levitation train in the vacuum environment, the central operation control system uses the air diffusion model established by the vacuum tube monitoring system to calculate the temporary speed limit, and controls the operating status of the train through the partition operation control system and the on-board operation control system, thereby avoiding the safety risk caused by the leakage of the low vacuum tube, realizing the safety protection of the train in the vacuum tube, greatly improving the reliability of the train operation in the vacuum environment, and ensuring the safety of the train operation.

Additional features and advantages of the invention will be set forth in the description which follows, and in part will be obvious from the description, or may be learned by practice of the invention. The objectives and other advantages of the invention may be realized and attained by the structure particularly pointed out in the written description and claims hereof as well as the appended drawings.

### BRIEF DESCRIPTION OF THE DRAWINGS

In order to explain the embodiments of the present invention or the technical solutions in the prior art more clearly, the drawings needed to be used in the description of the embodiments or the prior art will be briefly introduced below. Obviously, the drawings in the following description are the present invention. For some embodiments of the invention, those of ordinary skill in the art can further obtain other drawings based on these drawings without exerting creative efforts.

FIG. 1 shows a schematic flow chart of a method for protecting operations in a vacuum environment of an ultra-high-speed magnetic levitation low vacuum tube in an embodiment of the present invention;

FIG. 2 shows a process diagram for a train to perform temporary speed limit safe operation protection in an embodiment of the present invention;

FIG. 3 shows another process diagram for a train to perform temporary speed limit safe operation protection in an embodiment of the present invention;

FIG. 4 shows a process diagram for a train to perform safe operation protection of emergency braking in an embodiment of the present invention;

FIG. 5 shows another process diagram for a train to perform safe operation protection of emergency braking in an embodiment of the present invention;

FIG. 6 shows a structural diagram of a system for protecting operations in a vacuum environment of an ultra-high-speed magnetic levitation low vacuum tube in an embodiment of the present invention; and

FIG. 7 shows a structural diagram of another system for protecting operations in a vacuum environment of an ultra-high-speed magnetic levitation low vacuum tube in an embodiment of the present invention.

### DETAILED DESCRIPTION

In order to make the purpose, technical solutions and advantages of the embodiments of the present invention clearer, the technical solutions in the embodiments of the present invention will be clearly and completely described below with reference to the drawings in the embodiments of the present invention. Obviously, the described embodiments They are some embodiments of the present invention, not all embodiments. Based on the embodiments of the present invention, all other embodiments obtained by those of ordinary skill in the art without creative efforts fall within the scope of protection of the present invention.

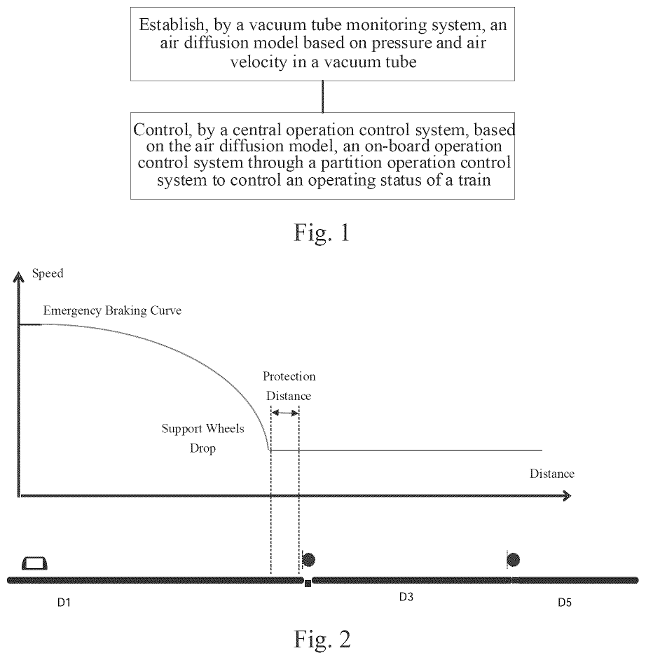

As shown in FIG. 1, an embodiment of the present invention discloses a method for protecting operations in a vacuum environment of an ultra-high-speed magnetic levitation low vacuum tube, which method includes: first, establishing, by a vacuum tube monitoring system, an air diffusion model based on pressure and air velocity in a vacuum tube; and controlling, by a central operation control system, based on the air diffusion model, an on-board operation control system through a partition operation control system to control an operating status of a train. When protecting the safe operating of a magnetic levitation train in vacuum environment, the central operation control system uses the air diffusion model established in vacuum tube monitoring system and controls the operating status of the train through the partition operation control system to avoid the safety risk caused by the leakage of the low vacuum tube, thus realizing the safety protection of the magnetic levitation train operating in the vacuum tube, greatly improving the reliability of the train operating in the vacuum environment and ensuring the safety of the train operating in the vacuum environment.

The air diffusion model is a relationship between the pressure change rate in the vacuum tube, the pressure in the vacuum tube and/or the air velocity and the operating status of the train. Furthermore, the air diffusion model is usually used when the vacuum tube leaks or the gate valve opens. At the same time, the corresponding operation control system may further control the gate valve and other equipment in the vacuum tube after the train stops. Specifically, first, the pressure change rate in the vacuum tube satisfies:

$$δ P = ( P 1 - P 2 ) / t 1 - t 2$$

wherein, P1 represents the pressure at time t1, and P2 represents the pressure at time t2.

Secondly, based on the pressure change rate in the vacuum tube, it is determined whether the current air in the vacuum tube is in a stable status, where when δP=0, it indicates that the current air in the vacuum tube is in the stable status; When δP≠0, it indicates that the current air in the vacuum tube is in an unstable status.

Therefore, the air diffusion model specifically includes:
1) When δP=0, it indicates that the current air in the vacuum tube is in the stable status, or the current air in the vacuum tube is in the unstable status, that is, δP≠0, but 0<δP≤the first pressure change rate. At this time, if the pressure P in the vacuum tube<the first pressure, as shown in Table 1: the operating status of the train and the air velocity V air in the vacuum tube satisfy the following relationship:

TABLE 1
Relationship between Train Operating Status and Air Velocity

| Air Velocity Vair in Tube | Operating Status of Train |
|---|---|
| Vair ≤ V1 | Traveling at a normal speed |
| V1 < Vair ≤ V2 | Traveling at a speed less than |
| | a first operating speed |
| V2 < Vair ≤ V3 | Traveling at a speed less than |
| | a second operating Speed |
| V3 < Vair ≤ V4 | The train travelling with the |
| | support wheels lowered |
| Vair > V4 | Train Stopping |

In the table, V1, V2, V3 and V4 respectively represent the first air velocity to the fourth air velocity, herein the value of V1 may be 15 m/s (meters/second), the value of V2 may be 20 m/s, the value of V3 may be 25 m/s, and the value of V4 may be 30 m/s, but they are not limited thereto, and the values of V1, V2, V3 and V4 may further be adaptively selected from other speed values. Further, the normal speed of the train is a speed greater than or equal to 300 km/h (kilometers/hour), and the normal speed of the train is a preset normal speed, such as 350 km/h, but is not limited thereto. Other preset normal speeds are further applicable to the present invention. The first operating speed may be 300 km/h, and the second operating speed may be 250 km/h, but is not limited thereto, and the first operating speed and the second operating speed may further be other speed values according to the train conditions. In addition, V1, V2, V3 and V4 may further be called leakage air velocities in the vacuum tube.

When the air pressure P≥the first pressure, the train operation is not affected, that is, it is determined the train to travel at the normal speed. The specific first pressure is 5000 Kpa (kilopascals), but is not limited thereto. For example, 4500 Kpa is further suitable for the present invention.

2) When the front air is in the unstable status, but δP>first pressure change rate, the following conditions are satisfied:

when the first pressure change rate<δP≤the second pressure change rate, it indicates that the current air is in the unstable status and the train slides by lowering the support wheels. The first pressure change rate may be 50 pa/h (Pa/hour), but is not limited thereto. According to the environmental requirements in the vacuum tube, changing the first pressure change rate to 45 pa/h is further applicable to the present invention.

When δP>the second pressure change rate, the train is determined to stop and prohibits operating through the speed limit zone. The value of the second pressure change rate may be 100 pa/h, but is not limited thereto. According to the environmental requirements in the vacuum tube, changing the first pressure change rate to 90 pa/h is further applicable to the present invention.

In the embodiment of the present invention, the central operation control system controls the on-board operation control system through the partition operation control system based on the air diffusion model to control the operating status of the train, including controlling the train to brake and stop. When Vair>the fourth air velocity V4 or δP>the second pressure change rate, it may be known based on the air diffusion model that the operating status of the train is train stop, so that the central operation control system sends a braking control instruction to the partition operation control system according to requirements for the operating status of the train in the air diffusion model, and the partition operation control system controls the train to brake and stop through the on-board operation control system.

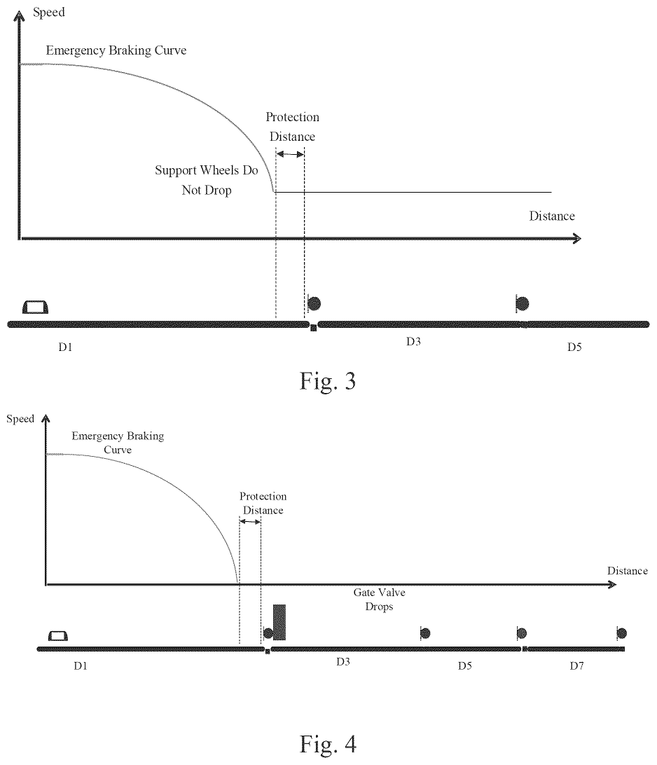

In the embodiment of the present invention, the central operation control system is based on the air diffusion model and controls the on-board operation control system through the partition operation control system to control the operating status of the train and further includes controlling a temporary speed limit of the train. Specifically, in the above air diffusion model, when the first air velocity V1<Vair≤the fourth air velocity V4 or the first pressure change rate<δP≤the second pressure change rate, the operating status of the train involves limiting the speed of the train, so that when the first air velocity V1<Vair≤the fourth air velocity V4 or the first pressure change rate<δP≤the second pressure change rate, the central operation control system calculates the temporary speed limit according to the air diffusion model, that is, obtains that the train operating speed meeting the requirements in the air diffusion model. Then, the central operation control system sends the temporary speed limit instruction and the calculated temporary speed limit to the partition operation control system;
based on the sent temporary speed limit instruction and the temporary speed limit, the partition operation control system controls the operating status of the train through the on-board operation control system. Specifically, the partition operation control system obtains the levitation speed of the train through the on-board operation control system and determines whether the temporary speed limit is lower than the levitation speed, where,
if the temporary speed limit is lower than the levitation speed, the partition operation control system controls the train to lower the support wheels through the on-board operation control system. After the support wheels of the train land, the train passes through the speed limited area at the temporary speed limit, that is, if V1<Vair≤V2 or V2<Vair≤V3, then at the temporary speed limit, the support wheels may also be lowered so that the train passes through the speed limited area at the temporary speed limit; otherwise, as shown in the figure, the partition operation control system controls the train to pass through the speed limited area at the levitation speed through the on-board operation control system. For example, as shown in FIG. 2, the partition operation control system determines that the temporary speed limit of the train is lower than the levitation speed, then the partition operation control system sends an instruction to the on-board operation control system to lower the support wheels of the train, and the on-board operation control system controls the train after the support wheels is lowered. After the support wheels of the train land, the train passes through the speed limited area at the temporary speed limit; otherwise, as shown in FIG. 3, the partition operation control system sends an instruction to the on-board operation control system to control the train to pass through the speed limited area at the levitation speed. Namely, at the temporary speed limit, the air diffusion model and the levitation speed of high-speed train are considered comprehensively. The above-mentioned double protection method ensures the safety of train operation. In addition, a protection distance in FIGS. 2 and 3 is a distance for satisfying that the train can finally decelerates to the temporary speed at the temporary speed limit.

In the embodiment of the present invention, when the speed of the train is less than 160 km/h and below, the support wheels must be lowered for operation.

By combining the air diffusion model with the train system operation control, the safety and reliability of train operation in the vacuum tube are effectively ensured.

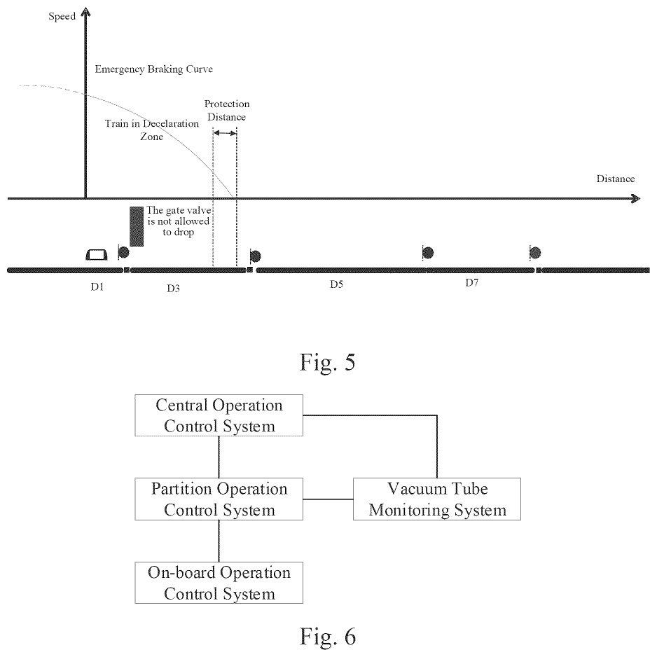

In the embodiment of the present invention, the vacuum pump is configured to evacuate the tube and maintain a low vacuum status; after the return pressure valve is opened, the tube is connected to the outside, and the vacuum tube is injected with the atmosphere; a gate valve is configured to close off a certain area, preventing entry into the train; the escape door is used for people to escape, so the vacuum tube monitoring system further operates and controls the gate valve, the return pressure valve, the escape door and/or the vacuum pump, under permission from the partition operation control system, specifically comprising the following steps. First, the vacuum tube monitoring system sends an operating status instruction to the partition operation control system; then, based on the operating status instruction, the partition operation control system checks whether the train is in a stopped status through the on-board operation control system. Finally, if the train is in the stopped status, it allows the vacuum tube monitoring system to control operations of the gate valve, the return pressure valve, the escape door and/or or the vacuum pump; otherwise, the vacuum tube monitoring system is not allowed to control operations of the gate valve, the return pressure valve, the escape door and/or or the vacuum pump. In order to ensure the safety of operation, the partition operation control system must monitor the status of the gate valve, the return pressure valve, and the escape door to prevent the train from intruding into the gate valve protected area or colliding with the gate valve, causing train risks and further ensuring the safety of train operation. For example, as shown in FIGS. 4 and 5, when the train stops by emergency braking, if the emergency braking stop has been completed, the vacuum tube system is allowed to operate the gate valve, the return pressure valve, the escape door, and the vacuum pump. Otherwise, the vacuum tube system is not allowed to control the operations of the gate valve, the return pressure valve, the escape door, the vacuum pump. The protection distance in the figure is a distance that satisfies that the train can completely stop. In addition, the above operations may be performed after emergency braking or temporary speed limitation to ensure the safety of the train.

In the embodiment of the present invention, the method further includes: by the central operation control system, remotely controlling operations of the gate valve, the return pressure valve, the escape door and/or the vacuum pump, under permission from the partition operation control system, including: by the vacuum tube monitoring system, sending an operating status instruction to the partition operation control system; by the partition operation control system, checking whether the train is in a stopped status through the on-board operation control system based on the operation status instruction, allowing the vacuum tube monitoring system to control the operations of the gate valve, the return pressure valve, the escape door and/or the vacuum pump if the train is in the stopped status; and otherwise, not allowing the vacuum tube monitoring system to control the operations of the gate valve, the return pressure valve, the escape door and/or the vacuum pump. In the same way, the above operations may be performed after emergency braking or temporary speed limitation to ensure the safety of the train.

As shown in FIG. 6, the embodiment of the present invention further introduces a system for protecting operations in a vacuum environment of an ultra-high-speed magnetic levitation low vacuum tube for executing the above method, and the system includes a central operation control system, a partition operation control system, an on-board operation control system and a vacuum tube monitoring system, wherein the central operation control system is connected to the partition operation control system and the vacuum tube monitoring system respectively, and the partition operation control system is further connected to the vacuum tube monitoring system and the on-board operation control system respectively, herein the vacuum tube monitoring system is configured to obtain pressure and air velocity in a vacuum tube, and establish an air diffusion model based on the pressure and the air velocity in the vacuum tube; and the central operation control system is configured to control the on-board operation control system through the partition operation control system to control an operating status of the train.

In the embodiment of the present invention, an air diffusion model is established based on the pressure and the air velocity in the vacuum tube, where the air diffusion model is consistent with the description in the above method and will not be described again here.

In the embodiment of the present invention, based on the air diffusion model, the on-board operation control system is controlled through the partition operation control system to control the operating status of the train, which is consistent with what is described in the above method, and will not be described again here.

In the embodiment of the present invention, the vacuum tube monitoring system is further configured to control the operations of the gate valve, the return pressure valve, the escape door and/or the vacuum pump, under permission from the partition operation control system, specifically comprising:
by the central operation control system, sending an operating status instruction to the partition operation control system;
by the partition operation control system, checking whether the train is in a stopped status through the on-board operation control system based on the operation status instruction,
if the train is in the stopped status, allowing the central operation control system to control the operations of the gate valve, the return pressure valve, the escape door and/or the vacuum pump; and
otherwise, not allowing the central operation control system to control the operations of the gate valve, the return pressure valve, the escape door and/or the vacuum pump.

In the embodiment of the present invention, the central operation control system is further configured to remotely control the operations of the gate valve, the return pressure valve, the escape door and/or the vacuum pump, under permission from the regional operation control system, specifically comprising:
by the central operation control system, sending an operating status instruction to the partition operation control system;
by the partition operation control system, checking whether the train is in a stopped status through the on-board operation control system based on the operation status instruction,
if the train is in the stopped status, allowing the central operation control system to remotely control the operations of the gate valve, the return pressure valve, the escape door and/or the vacuum pump; and
otherwise, not allowing the central operation control system to remotely control the operations of the gate valve, the return pressure valve, the escape door and/or the vacuum pump.

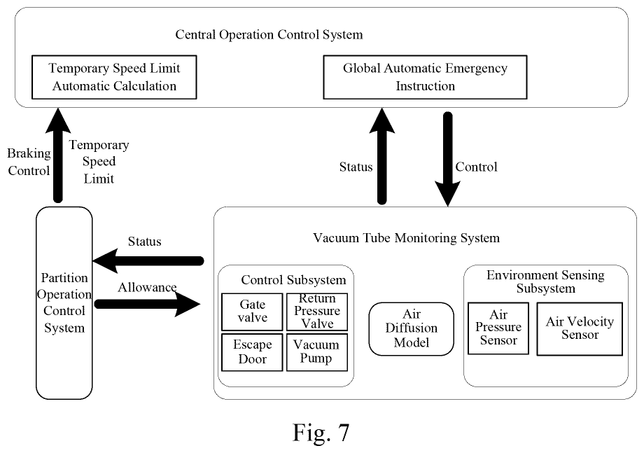

As shown in FIG. 7, the embodiment of the present invention further introduces a system for protecting operations in a vacuum environment of an ultra-high-speed magnetic levitation low vacuum tube capable of performing the above protection method, the system includes a central operation control system, a partition operation control system, an on-board operation control system and a vacuum tube monitoring system, wherein the central operation control system is connected to the partition operation control system and the vacuum tube monitoring system respectively, and the partition operation control system is further connected to the vacuum tube monitoring system and the on-board operation control system respectively, herein the vacuum tube monitoring system includes an air diffusion calculation module, a control subsystem, an environment sensing subsystem, a door valve, a return pressure valve, an escape door, a vacuum pump, an air pressure sensor and an air velocity sensor, wherein the air pressure sensor and the air velocity sensor are respectively connected to the environment sensing subsystem and are configured to collect pressure and air velocity in the vacuum tube respectively, and the air diffusion calculation module is connected to the environment sensing subsystem and is configured to calculate the pressure and the air velocity in the vacuum tube provided by the environment sensing subsystem, to establish an air diffusion model; and the control subsystem is connected with the gate valve, the return pressure valve, the escape door, and the vacuum pump in the vacuum tube, and is configured to control the gate valve, the return pressure valve, the escape door, and the vacuum pump. Further, the air diffusion model is usually used when the vacuum tube leaks or the gate valve is opened.

The central operation control system includes a temporary speed limit automatic calculation module and a global automatic emergency instruction module, herein the temporary speed limit automatic calculation module is connected with the global automatic emergency instruction module, wherein the global automatic emergency instruction module is connected with the air diffusion calculation module of the vacuum tube monitoring system for obtaining an air diffusion model and sending the air diffusion model to the temporary speed limit automatic calculation module, wherein the temporary speed limit calculation module is configured to calculate a temporary speed limit based on the air diffusion model.

The partition operation control system is configured to control an operating status of the train through the on-board operation control system according to a control instruction sent by the central operation control system based on the air diffusion model.

In the embodiment of the present invention, the central operation control system further includes a remote operation terminal (not shown in the figures) for remotely controlling the operations of the gate valve, the return pressure valve, the escape door, and the vacuum pump.

In the embodiment of the present invention, the partition operation control system is further configured to monitor the gate valve, the return pressure valve, the escape door, and the vacuum pump, and before the central operation control system or the control subsystem controls the operations of the gate valve, the return pressure valve, the escape door and/or before the vacuum pump is operated and controlled, permission confirmation is performed.

When the system protects the safe operation of the magnetic levitation train in the vacuum environment, the central operation control system calculates the temporary speed limit using the air diffusion model established by the vacuum tube monitoring system, controls the operating status of the train through the partition operation control system and the on-board operation control system, realizes the safety protection of the train in the vacuum tube, avoids the safety risk caused by the leakage of the low vacuum tube, greatly improves the reliability of the train operation in the vacuum environment, and ensures the safety of the train operation.

Although the present invention has been described in detail with reference to the foregoing embodiments, those of ordinary skill in the art should understand that they can still modify the technical solutions described in the foregoing embodiments, or replace some of the technical features with equivalents; However, these modifications or substitutions do not cause the essence of the corresponding technical solution to deviate from the spirit and scope of the technical solution of each embodiment of the present invention.

1. A method for protecting operations in a vacuum environment of an ultra-high-speed magnetic levitation low vacuum tube, comprising:
establishing, by a vacuum tube monitoring system, an air diffusion model based on pressure and air velocity in a vacuum tube; and
controlling, by a central operation control system, based on the air diffusion model, an on-board operation control system through a partition operation control system to control an operating status of a train.

2. The method for preventing operations in the vacuum environment of the ultra-high-speed magnetic levitation low vacuum tube according to claim 1, wherein, the establishing, by a vacuum tube monitoring system, an air diffusion model based on pressure and air velocity in a vacuum tube comprises:
determining, based on a pressure change rate in the vacuum tube, whether current air in the vacuum tube is in a stable status,
if the current air in the vacuum tube is in the stable status, determining an operating status of the train based on the pressure and/or the air velocity in the vacuum tube; and
otherwise, determining the operating status of the train based on the pressure change rate in the vacuum tube.

3. The method for protecting operations in the vacuum environment of the ultra-high-speed magnetic levitation low vacuum tube according to claim 2, wherein, the pressure change rate δP in the vacuum tube satisfies:
δP=(P1−P2)/(t1−t2)
wherein, P1 represents the pressure at time t1, and P2 represents the pressure at time t2;
when δP=0, it indicates that the current air in the vacuum tube is in the stable status; and
when δP≠0, it indicates that the current air in the vacuum tube is in an unstable status.

4. The method for protecting operations in the vacuum environment of the ultra-high-speed magnetic levitation low vacuum tube according to claim 3, wherein, if the current air in the vacuum tube is in the stable status, or if the current air in the vacuum tube is in the unstable status but 0<δP≤a first pressure change rate, the determining an operating status of the train based on the pressure and/or the air velocity in the vacuum tube comprises:
if the pressure P in the vacuum tube<a first pressure, then making the operating status of the train and the air velocity Vair in the vacuum tube satisfy the following relationships that:
when Vair≤a first air velocity V1, the train travels at a normal operating speed;
when the first air velocity V1<Vair≤a second air velocity V2, the train travels at a speed less than a first operating speed;
when the second air velocity V2<Vair≤a third air velocity V3, the train travels at a speed less than a second operating speed;
when the third air velocity V3<Vair≤a fourth air velocity V4, the train travels with support wheels lowered; and
when Vair>the fourth air velocity V4, the train stops; and
if the pressure P in the vacuum tube≥the first pressure, the train travels at the normal operating speed.

5. The method for protecting operations in the vacuum environment of the ultra-high-speed magnetic levitation low vacuum tube according to claim 4, wherein, if the current air in the vacuum tube is in the unstable status but δP>the first pressure change rate, the determining the operating status of the train based on the pressure change rate in the vacuum tube comprises determining that:
when the first pressure change rate<δP≤a second pressure change rate, the train travels with the support wheels lowered; and
when δP>the second pressure change rate, the train stops.

6. The method for protecting operations in the vacuum environment of the ultra-high-speed magnetic levitation low vacuum tube according to claim 5, wherein, the controlling, by the central operation control system, based on the air diffusion model, the on-board operation control system through the partition operation control system to control the operating status of the train comprises:
if Vair>the fourth air velocity V4 or δP>the second pressure change rate, sending, by the central operation control system, a braking control instruction to the partition operation control system, and controlling, by the partition operation control system, the train to brake and stop through the on-board operation control system.

7. The method for protecting operations in the vacuum environment of the ultra-high-speed magnetic levitation low vacuum tube according to claim 5, wherein, the controlling, by the central operation control system, based on the air diffusion model, the on-board operation control system through the partition operation control system to control the operating status of the train further comprises:
if the first air velocity V1<Vair≤the fourth air velocity V4 or the first pressure change rate<δP≤the second pressure change rate, by the central operation control system, calculating a temporary speed limit, and sending a temporary speed limit instruction and the calculated temporary speed limit to the partition operation control system; and
controlling, by the partition operation control system, the operating status of the train through the on-board operation control system, based on the temporary speed limit instruction and the temporary speed limit.

8. The method for protecting operations in the vacuum environment of the ultra-high-speed magnetic levitation low vacuum tube according to claim 7, wherein, the controlling, by the partition operation control system, the operating status of the train through the on-board operation control system based on the temporary speed limit instruction and the temporary speed limit further comprises:
by the partition operation control system, obtaining a levitation speed of the train through the on-board operation control system, and determining whether the temporary speed limit of the train is lower than the levitation speed,
if the temporary speed limit is lower than the levitation speed, by the partition operation control system, controlling the train to lower the support wheels through the on-board operation control system, and after the support wheels of the train land, controlling the train to pass through a speed limited area at the temporary speed limit; and
otherwise, controlling, by the partition operation control system, the train to pass through the speed limited area at the levitation speed through the on-board operation control system.

9. The method for protecting operations in the vacuum environment of the ultra-high-speed magnetic levitation low vacuum tube according to claim 1, further comprising controlling, by a vacuum tube monitoring system, operations of a gate valve, a return pressure valve, an escape door and/or a vacuum pump under permission from the partition operation control system, specifically comprising:
sending, by the vacuum tube monitoring system, an operating status instruction to the partition operation control system;
checking, by the partition operation control system, whether the train is in a stopped status through the on-board operation control system based on the operation status instruction,
if the train is in the stopped status, allowing the vacuum tube monitoring system to control the operations of the gate valve, the return pressure valve, the escape door and/or the vacuum pump; and
otherwise, not allowing the vacuum tube monitoring system to control the operations of the gate valve, the return pressure valve, the escape door and/or the vacuum pump.

10. The method for protecting operations in the vacuum environment of the ultra-high-speed magnetic levitation low vacuum tube according to claim 1, further comprising remotely controlling, by a central operation control system, operations of a gate valve, a return pressure valve, an escape door and/or a vacuum pump, under permission from the partition operation control system, specifically comprising,
sending, by the central operation control system, an operating status instruction to the partition operation control system;
checking, by the partition operation control system, whether the train is in a stopped status through the on-board operation control system based on the operation status instruction,
if the train is in the stopped status, allowing the central operation control system to remotely control the operations of the gate valve, the return pressure valve, the escape door and/or the vacuum pump; and
otherwise, not allowing the central operation control system to remotely control the operations of the gate valve, the return pressure valve, the escape door and/or the vacuum pump.

11. A system for protecting operations in a vacuum environment of an ultra-high-speed magnetic levitation low vacuum tube, comprising a central operation control system, a partition operation control system, an on-board operation control system and a vacuum tube monitoring system, wherein the central operation control system is connected to the partition operation control system and the vacuum tube monitoring system respectively, and the partition operation control system is further connected to the vacuum tube monitoring system and the on-board operation control system respectively, wherein,
the vacuum tube monitoring system is configured to obtain pressure and air velocity in the vacuum tube, and establish an air diffusion model based on the pressure and the air velocity in the vacuum tube; and
the central operation control system is configured to control the on-board operation control system through the partition operation control system to control an operating status of a train based on the air diffusion model.

12. The system for protecting operations in the vacuum environment of the ultra-high-speed magnetic levitation low vacuum tube according to claim 11, wherein, the vacuum tube monitoring system is configured to establish the air diffusion model based on the pressure and the air velocity in the vacuum tube by:
determining, based on a pressure change rate in the vacuum tube, whether current air in the vacuum tube is in a stable status; wherein, the pressure change rate δP in the vacuum tube satisfies:
δP=(P1−P2)/(t1−t2)
wherein, P1 represents the pressure at time t1, and P2 represents the pressure at time t2;
when δP=0, it indicates that the current air in the vacuum tube is in the stable status; when δP≠0, it indicates that the current air in the vacuum tube is in an unstable status;
wherein if the current air in the vacuum tube is in the stable status, or if the current air in the vacuum tube is in the unstable status but 0<δP≤a first pressure change rate, then the operating status of the train is determined based on the current pressure and/or air velocity in the vacuum tube, wherein,
if the pressure P in the vacuum tube<a first pressure, then the operating status of the train and the air velocity Vair in the vacuum tube satisfy the following relationships that:
when Vair≤the first air velocity V1, the train travels at a normal operating speed;
when the first air velocity V1<Vair≤a second air velocity V2, the train travels at a speed less than a first operating speed;
when the second air velocity V2<Vair≤a third air velocity V3, the train travels at a speed less than a second operating speed;
when the third air velocity V3<Vair≤a fourth air velocity V4, the train travels with the support wheels lowered; and
when Vair>a fourth air velocity V4, the train stops; and
if the pressure P in the vacuum tube≥the first pressure, the train travels at the normal operating speed, and
if the current air in the vacuum tube is in the unstable status, but δP>the first pressure change rate, determining the operating status of the train based on the pressure change rate in the vacuum tube, wherein,
when the first pressure change rate<δP≤a second pressure change rate, the train travels with the support wheels lowered; and
when δP>the second pressure change rate, the train stops.

13. The system for protecting operations in the vacuum environment of the ultra-high-speed magnetic levitation low vacuum tube according to claim 12, wherein, the central operation control system is configured control the on-board operation control system through the partition operation control system to control the operating status of the train based on the air diffusion model by:
if Vair>the fourth air velocity V4 or δP>the second pressure change rate, sending, by the central operation control system, a braking control instruction to the partition operation control system, and controlling, by the partition operation control system, the train to brake and stop through the on-board control system.

14. The system for protecting operations in the vacuum environment of the ultra-high-speed magnetic levitation low vacuum tube according to claim 13, wherein, the central operation control system is configured control the on-board operation control system through the partition operation control system to control the operating status of the train based on the air diffusion model by:
if the first air velocity V1<Vair≤the fourth air velocity V4 or the first pressure change rate<δP≤the second pressure change rate, by the central operation control system, calculating a temporary speed limit, and sending a temporary speed limit instruction and the calculated temporary speed limit to the partition operation control system;
controlling, by the partition operation control system, the operating status of the train through the on-board operation control system, based on the temporary speed limit instruction and the temporary speed limit, specifically comprising:
by the partition operation control system, obtaining a levitation speed of the train through the on-board operation control system, and determining whether the temporary speed limit of the train is lower than the levitation speed, wherein,
if the temporary speed limit is lower than the levitation speed, by the partition operation control system, controlling the train to lower the support wheels through the on-board operation control system, and after the support wheels of the train land, controlling the train to pass through a speed limited area at the temporary speed limit; and
otherwise, by the partition operation control system, controlling the train to pass through the speed limited area at the levitation speed through the on-board operation control system.

15. The system for protecting operations in the vacuum environment of the ultra-high-speed magnetic levitation low vacuum tube according to claim 11, wherein, the vacuum tube monitoring system is further configured to control operations of a gate valve, a return pressure valve, an escape door and/or a vacuum pump, under permission from the partition operation control system, specifically comprising, sending, by the vacuum tube monitoring system, an operating status instruction to the partition operation control system;
checking, by the partition operation control system, whether the train is in a stopped status through the on-board operation control system based on the operation status instruction,
if the train is in the stopped status, allowing the vacuum tube monitoring system to control the operations of the gate valve, the return pressure valve, the escape door and/or the vacuum pump; and
otherwise, not allowing the vacuum tube monitoring system to control the operations of the gate valve, the return pressure valve, the escape door and/or the vacuum pump.

16. The system for protecting operations in the vacuum environment of the ultra-high-speed magnetic levitation low vacuum tube according to claim 11, wherein, the central operation control system is further configured to remotely control operations of a gate valve, a return pressure valve, an escape door and/or a vacuum pump, under permission from the partition operation control system, specifically comprising,
sending, by the central operation control system, an operating status instruction to the partition operation control system;
checking, by the partition operation control system, whether the train is in a stopped status through the on-board operation control system based on the operation status instruction,
if the train is in the stopped status, allowing the central operation control system to remotely control the operations of the gate valve, the return pressure valve, the escape door and/or the vacuum pump; and
otherwise, not allowing the central operation control system to remotely control the operations of the gate valve, the return pressure valve, the escape door and/or the vacuum pump.

17. A system for protecting operations in a vacuum environment of an ultra-high-speed magnetic levitation low vacuum tube, comprising a central operation control system, a partition operation control system, an on-board operation control system and a vacuum tube monitoring system, wherein the central operation control system is connected to the partition operation control system and the vacuum tube monitoring system respectively, and the partition operation control system is further connected to the vacuum tube monitoring system and the on-board operation control system respectively, wherein,
the vacuum tube monitoring system includes an air diffusion calculation module, a control subsystem, an environment sensing subsystem, a door valve, a return pressure valve, an escape door, a vacuum pump, an air pressure sensor and an air velocity sensor, wherein the air pressure sensor and the air velocity sensor are respectively connected to the environment sensing subsystem and are configured to collect pressure and air velocity in the vacuum tube respectively, and the air diffusion calculation module is connected to the environment sensing subsystem and is configured to calculate the pressure and the air velocity in the vacuum tube provided by the environment sensing subsystem, to establish an air diffusion model; and the control subsystem is connected with the gate valve, the return pressure valve, the escape door, and the vacuum pump in the vacuum tube, and is configured to control the gate valve, the return pressure valve, the escape door, and the vacuum pump;
the central operation control system comprises a temporary speed limit automatic calculation module and a global automatic emergency instruction module, wherein the temporary speed limit automatic calculation module is connected with the global automatic emergency instruction module, wherein the global automatic emergency instruction module is connected with the air diffusion calculation module of the vacuum tube monitoring system for obtaining an air diffusion model and sending the air diffusion model to the temporary speed limit automatic calculation module, wherein the temporary speed limit calculation module is configured to calculate a temporary speed limit based on the air diffusion model; and
the partition operation control system is configured to control an operating status of the train through the on-board operation control system according to a control instruction sent by the central operation control system based on the air diffusion model.

18. The system for protecting operations in the vacuum environment of the ultra-high-speed magnetic levitation low vacuum tube according to claim 17, wherein, the central operation control system further comprises a remote operation terminal for remotely controlling operations of the gate valve and the return pressure valve, the escape door, and the vacuum pump.

19. The system for protecting operations in the vacuum environment of the ultra-high-speed magnetic levitation low vacuum tube according to claim 18, wherein, the partition operation control system is further configured to monitor the gate valve, the return pressure valve, the escape door, and the vacuum pump, and before the central operation control system or the control subsystem controls the operations of the gate valve, the return pressure valve, the escape door and/or the vacuum pump, permission confirmation is performed.
